(19) United States
(12) Patent Application Publication
(10) Pub. No.: US 2012/0054033 A1
(43) Pub. Date: Mar. 1, 2012

(54) Dynamically Providing Advertisement Data

(75) Inventors: Gerald Geurkink, Lexington, KY (US); Timothy D. Campbell, Lexington, KY (US)

(73) Assignee: IHIGH.COM, INC., Lexington, KY (US)

(21) Appl. No.: 13/178,129

(22) Filed: Jul. 7, 2011

Related U.S. Application Data
(63) Continuation of application No. PCT/US2011/042802, filed on Jul. 1, 2011.
(60) Provisional application No. 61/379,161, filed on Sep. 1, 2010.

(51) Int. Cl. G06Q 30/00

(52) U.S. Cl. 705/14.58; 705/14.49; 705/14.66

(57) ABSTRACT

Embodiments disclosed herein include systems, methods, and non-transitory computer-readable mediums for dynamically providing advertisement data. Some embodiments receive uploaded content from an uploading computing device, receive a desired break time and a desired break duration for the uploaded content, and determine a content target demographic for the uploaded content. Similarly, some embodiments are configured to determine advertisement content that corresponds to the content target demographic, create a tag for the uploaded content that indicates the desired break time and the desired break duration of a break, and store the tag for a subsequent content request of the uploaded content.

### CROSS REFERENCE

This application is a continuation of PCT/US2011/42802 filed Jul. 1, 2011, which claims the benefit of U.S. Provisional Application No. 61/379,161 filed Sep. 1, 2010 and entitled Dynamically Providing Advertisement Data, both of which are incorporated by reference in their entireties.

### BACKGROUND

As bandwidth and transmission speeds increase across the Internet, more content such as audio, video, and imagery is available to end-users. In many current solutions, content uploaders and/or content providers may provide advertisements within the content itself. Such current solutions however, often rely on statically including the advertisements, without regard to geography, target demographic, or other advertising concerns. Consequently, because many current solutions statically include advertisements in the content, the advertisements are generally stored with the content (sometimes as a single file). Such configurations increase storage requirements for the content, as well as reduce the ability to change the advertisements shown in subsequent viewings.

### SUMMARY

Embodiments disclosed herein include systems, methods, and non-transitory computer-readable mediums for dynamically providing advertisement data. Some embodiments include a memory component that stores a program that causes the system to receive uploaded content from an uploading computing device, receive a desired break time and a desired break duration for the uploaded content, and determine a content target demographic for the uploaded content. Similarly, some embodiments are further configured to determine advertisement content that corresponds to the content target demographic, create a tag for the uploaded content that indicates the desired break time and the desired break duration of a break, and store the tag for a subsequent content request of the uploaded content.

Also disclosed herein are embodiments of a method for dynamically providing advertisement data. Embodiments of the method include receiving uploaded content from an uploading computing device, receiving a desired break time and a desired break duration of a desired break for the uploaded content, and determining a content target demographic for the uploaded content. Some embodiments include determining advertisement content that corresponds to the content target demographic, creating, by a content providing computing device, a tag for the uploaded content that indicates the desired break time and the desired break duration, receiving a request for the uploaded content, the request being received from an end-user computing device, and determining an end-user demographic of an end-user that requested the uploaded content. Still some embodiments include retrieving the uploaded content and the tag and providing the uploaded content to the end-user computing device for presentation.

Further, embodiments of a non-transitory computer-readable medium are also disclosed. The non-transitory computer-readable medium may be configured to store a program that when executed by a computing device cause the computing device to receive uploaded content from an uploading computing device, receive a break time and a break duration of a break for the uploaded content, and determine a content target demographic. Some embodiments further cause the computing device to create a tag for the uploaded content that indicates the break time and the break duration, store the tag for subsequent content request, and receive a request for the uploaded content, the request being received from an end-user computing device. Still some embodiments cause the computing device to determine an end-user demographic for an end-user of the uploaded content, retrieve the uploaded content and the tag, provide the uploaded content to the end-user for presentation, and determine, from the tag, whether the break has been reached in presentation of the uploaded content. Some embodiments cause the computing device to determine whether the end-user demographic is substantially similar to the content target demographic and in response to determining that the end-user demographic is substantially similar to the content target demographic, provide, during the break, an advertisement to the end-user in place of the uploaded content.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

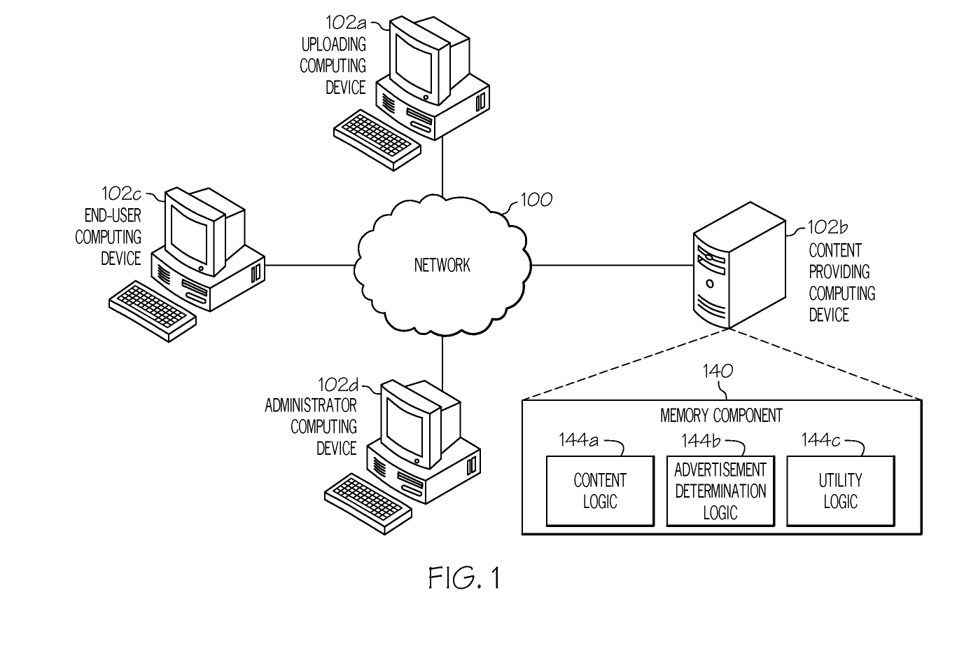

FIG. 1 depicts a network environment for dynamically providing advertisement data to an end-user computing device, according to embodiments shown and described herein;

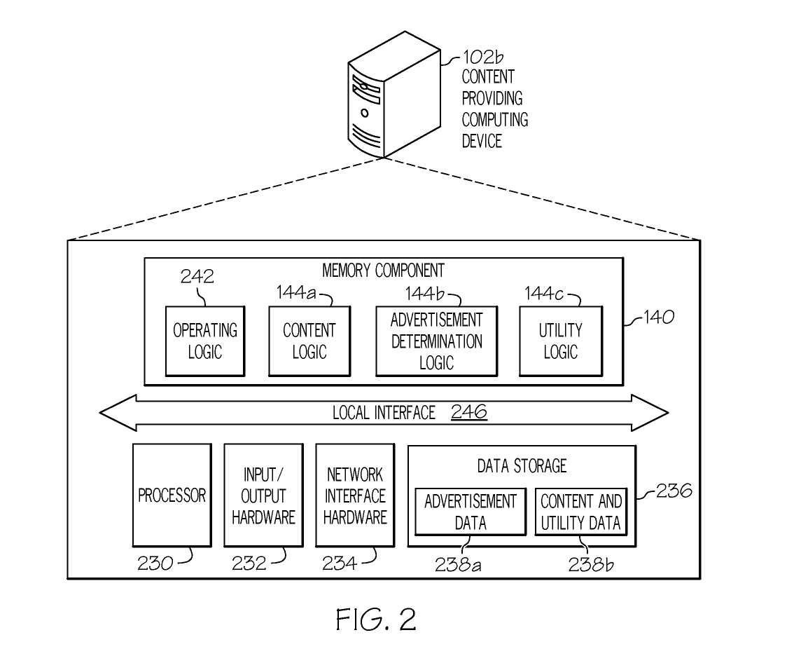

FIG. 2 depicts a content providing computing device for providing content to an end-user computing device, according to embodiments shown and described herein;

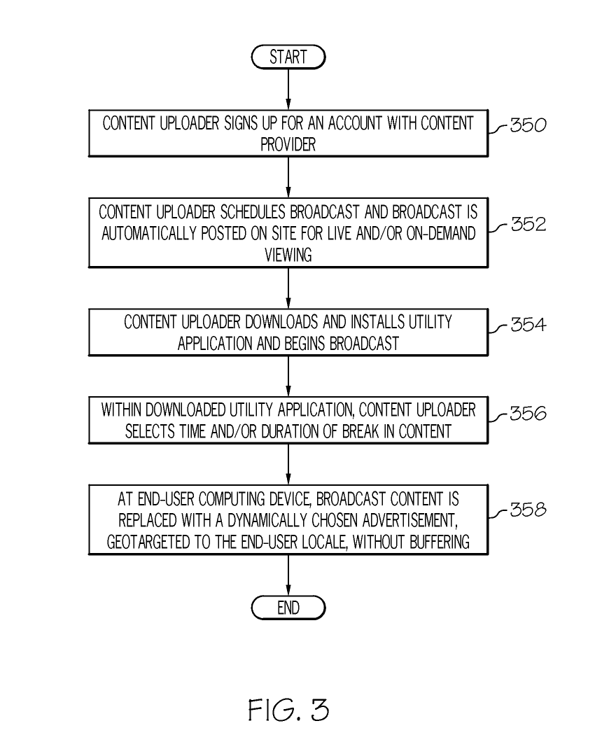

FIG. 3 depicts a flowchart for dynamically including advertisement data within content, according to embodiments shown and described herein;

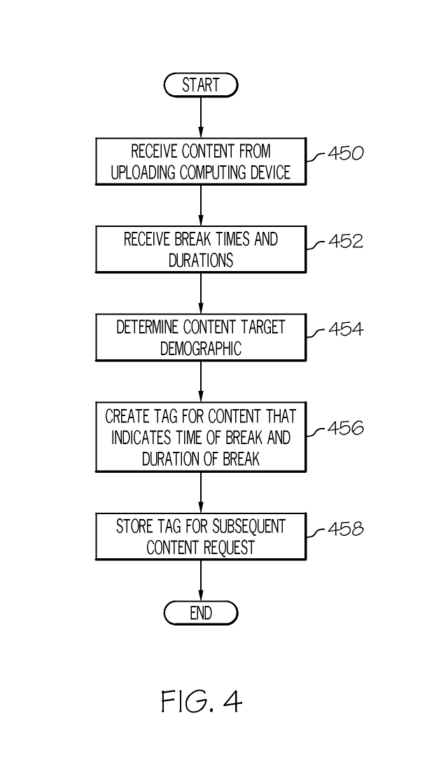

FIG. 4 depicts a flowchart for receiving on-demand content from a content uploading computing device, according to embodiments shown and described herein;

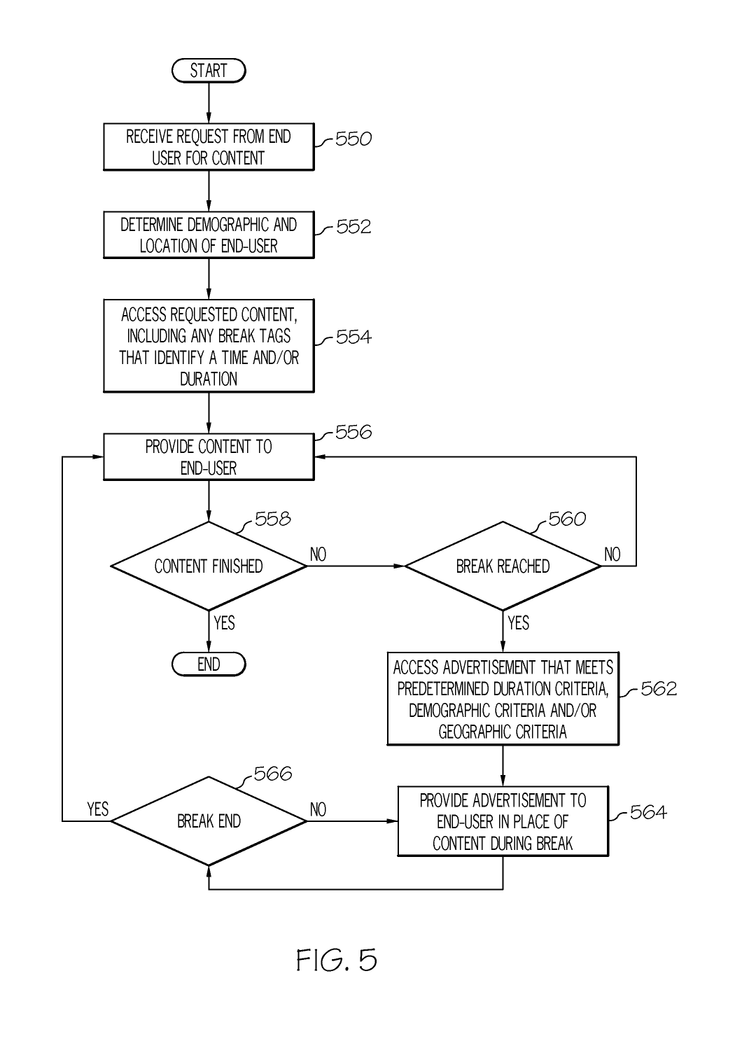

FIG. 5 depicts a flowchart for providing on-demand content with dynamically included advertisements to an end-user computing device, according to embodiments shown and described herein;

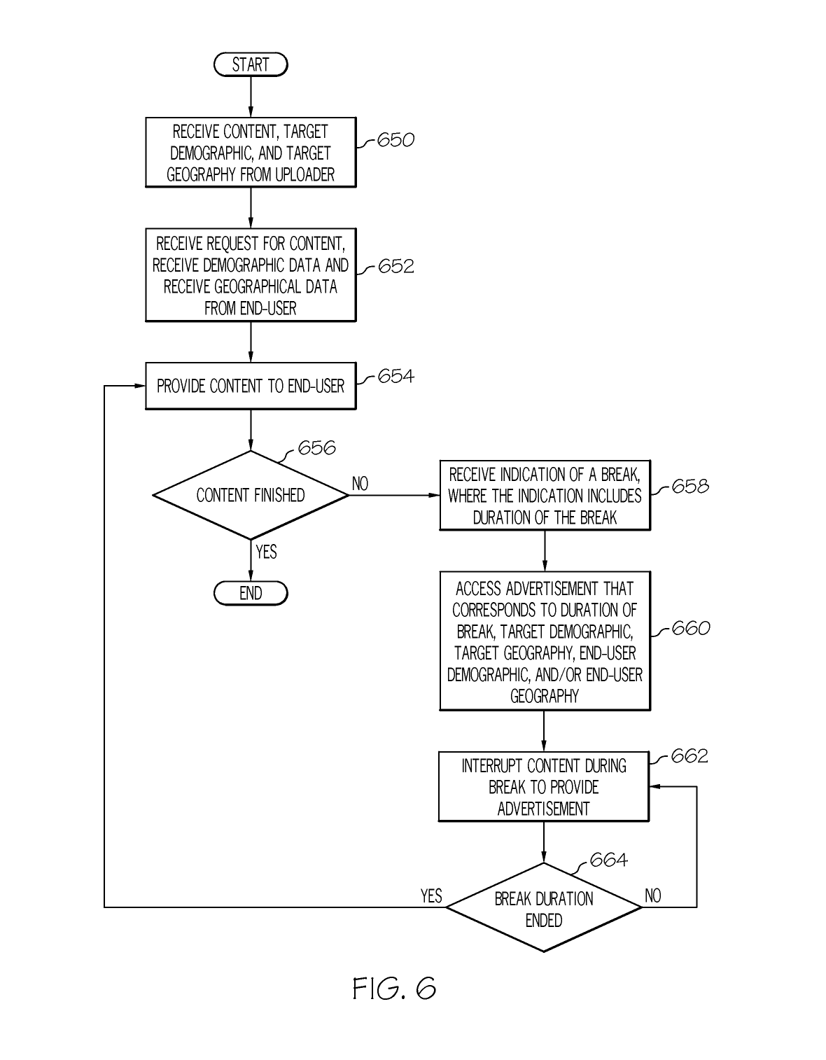

FIG. 6 depicts a flowchart for providing broadcast content and including dynamically included advertisements to an end-user computing device, according to embodiments shown and described herein;

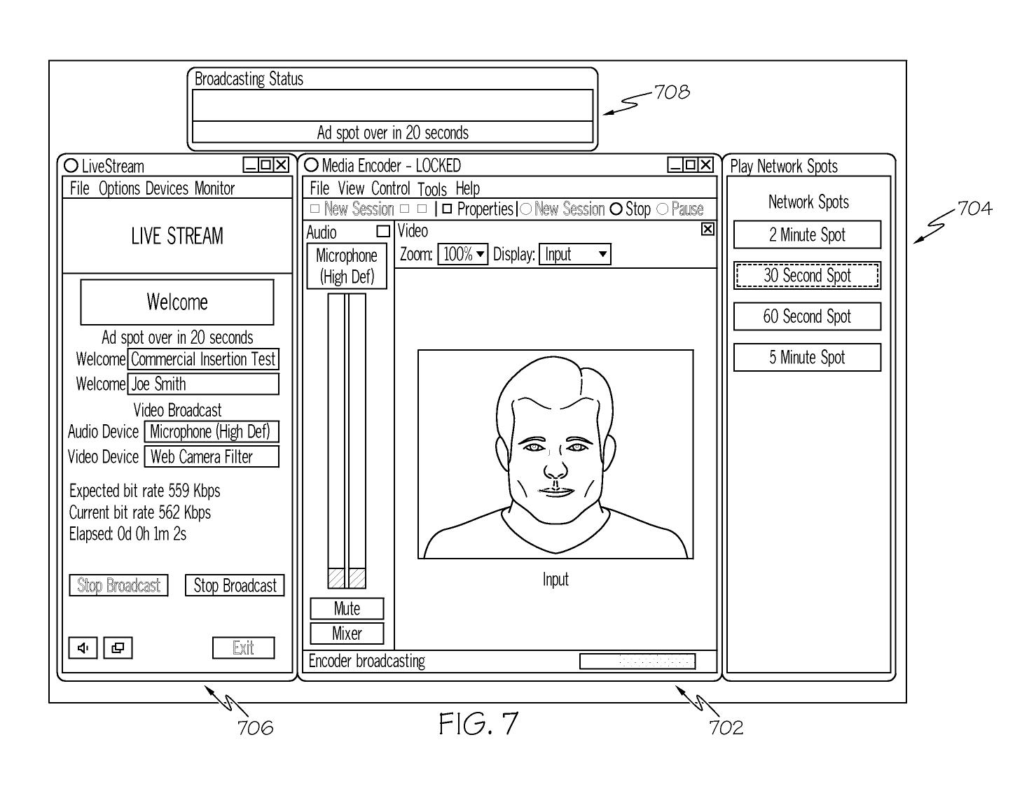

FIG. 7 depicts a screenshot of a user interface that may be provided on a content uploading computing device for a content uploader to dynamically include an advertisement within broadcast content, according to embodiments shown and described herein; and

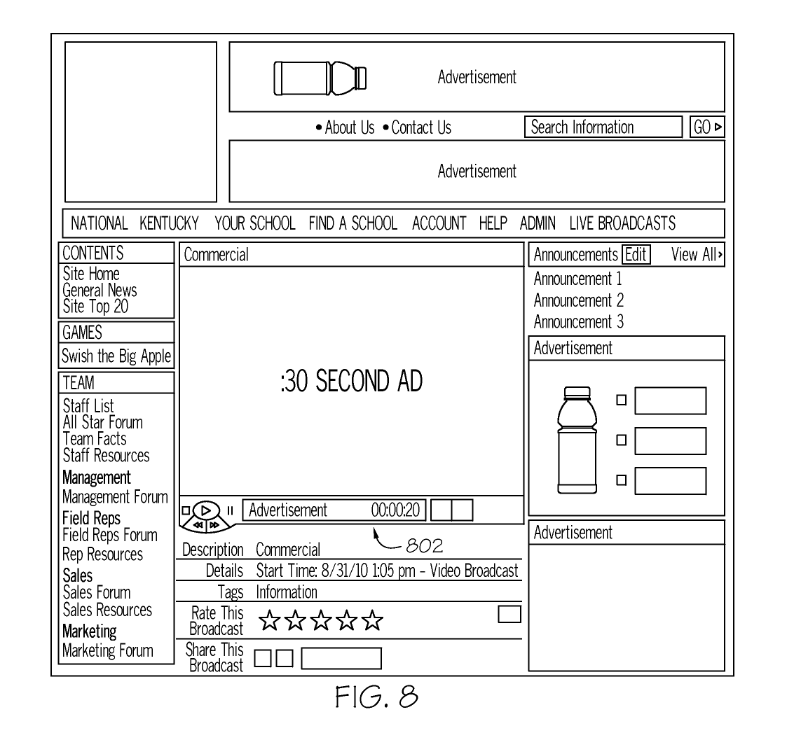

FIG. 8 depicts a screenshot of a user interface that may be provided on an end-user computing device, illustrating dynamic inclusion of an advertisement within content, according to embodiments shown and described herein.

### DETAILED DESCRIPTION

Embodiments disclosed herein provide systems, methods, and non-transitory computer-readable mediums for dynamically providing advertisement data within content. Accordingly, some embodiments may be configured to offer a single stream of content (such as an inauguration or the Olympics) to many viewers, while some embodiments may be configured to provide many different content streams to many viewers. Services offered to content uploading entities such as schools, offices, churches, governments, etc. may be controlled by those entities themselves. The uploading entities may control scheduling broadcasts, uploading photos, posting articles, and ultimately inserting an advertisement that is selected from advertisement content into their live broadcasts and/or stored content, such as on-demand content. Additionally, embodiments disclosed herein may be configured to allow the content uploader to choose a desired break time and/or desired break duration for an advertisement. The advertisement may be included dynamically by the uploading user, who selects an option that corresponds with the amount of time for the advertisement. The advertisement may then be selected by the content provider, based on predetermined criteria received from the content uploader and/or end-user. Because the uploading user is only identifying criteria associated with a desired advertisement and the content provider is interrupting the content to include an advertisement during a desired time, the content may be stored without any associated advertisements. This not only may reduce storage requirements for the content, but allows different advertisements to be provided to different end-users and during different viewings.

Referring now to the drawings, FIG. 1 depicts a computing environment, illustrating components for a system for dynamically providing advertisement data, according to embodiments shown and described herein. As illustrated in FIG. 1, a computer network 100 may include a wide area network, such as the Internet, a local area network (LAN), a mobile communications network, a public service telephone network (PSTN) and/or other network and may be configured to electronically couple an uploading computing device 102a, a content providing computing device 102b, an end-user computing device 102c, and an administrator computing device 102d.

More specifically, the uploading computing device 102a may be configured to upload content, such as audio data streams, video data streams, imagery, and/or other data to the content providing computing device 102b. The content providing computing device 102b may include a memory component 140 that stores content logic 144a, advertisement determination logic 144b, and utility logic 144c and may be configured to receive the uploaded content and advertisements. The content providing computing device 102b may also receive advertisement timing data, such as a time for interruption and a duration for interruption from the uploading computing device 102a. The content providing computing device 102b may also receive a request from the end-user computing device 102c for the content. The content providing computing device 102b may provide the requested content and dynamically include advertisements within the content, as indicated by the uploading computing device 102a.

As described herein, the content providing computing device 102b may be configured to dynamically include advertisement data within broadcast (and/or on-demand) content. More specifically, the content providing computing device 102b may receive tag data with the content that identifies a time and/or duration for inserting an advertisement within the content. The content providing computing device 102b can then access an advertisement that matches the desired criteria. Upon reaching the time for the advertisement, the content providing computing device 102b can interrupt the content to provide the advertisement for the identified duration.

Additionally, included in FIG. 1 is the administrator computing device 102d. In the event that the content providing computing device 102b requires oversight, updating, and/or correction, the administrator computing device 102d may be configured to provide the desired oversight, updating, and/or correction.

It should be understood that while the uploading computing device 102a, the content providing computing device 102b, the end-user computing device 102c, and the administrator computing device 102d are depicted as personal computers and/or servers, these are merely examples. More specifically, in some embodiments, any type of computing device (e.g. mobile computing device, personal computer, server, etc.) may be utilized for any of these components. Additionally, while each of these computing devices is illustrated in FIG. 1 as a single piece of hardware, this is also an example. More specifically, each of the computing devices 102a-102d may represent a plurality of computers, servers, databases, etc.

FIG. 2 depicts the content providing computing device 102b that may be configured to dynamically provide advertisement data within content, according to embodiments disclosed herein. In the illustrated embodiment, the content providing computing device 102b includes a processor 230, input/output hardware 232, network interface hardware 234, a data storage component 236 (which stores advertisement data 238a and content and utility data 238b), and a memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the content providing computing device 102b and/or external to the content providing computing device 102b.

Additionally, the memory component 140 may be configured to store operating logic 242, the content logic 144a, the advertisement determination logic 144b, and the utility logic 144c, each of which may be embodied as a computer program, firmware, and/or hardware, as an example. A local interface 246 is also included in FIG. 2 and may be implemented as a bus or other interface to facilitate communication among the components of the content providing computing device 102b.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, such as the wireless communications device 104 or other antenna, a modem, LAN port, wireless fidelity (Wi-Fi) card, WiMax card, mobile communications hardware, and/or other hardware for communicating with other networks and/or devices. From this connection, communication may be facilitated between the content providing computing device 102b and other computing devices.

Similarly, it should be understood that the data storage component 236 may reside local to and/or remote from the content providing computing device 102b and may be configured to store one or more pieces of data for access by the content providing computing device 102b and/or other components. As illustrated in FIG. 2, the data storage component 236 stores advertisement data 238a, which in some embodiments includes audio, video, and/or image data that may be utilized as an advertisement. Similarly, the content and utility data may include content that has been received by the uploading computing device 102a, as well as a utility application that may be provided to the uploading computing device 102a and/or to the end-user computing device 102c.

Included in the memory component 140 are the operating logic 242, the content logic 144a, the advertisement determination logic 144b, and the utility logic 144c. The operating logic 242 may include an operating system and/or other software for managing components of the content providing computing device 102b. Similarly, the content logic 144a may reside in the memory component 140 and may be configured to cause the processor 230 receive content from the uploading computing device 102a, as well as provide the content to the end-user computing device 102c. Additionally, the advertisement determination logic 144b may be configured to cause the processor 230 to receive tag data that includes one or more times and/or durations for interrupting the content to provide an advertisement. The utility logic 144c may be configured to receive requests for a utility application from the uploading computing device 102a and/or from the end-user computing device 102c.

It should be understood that the components illustrated in FIG. 2 are merely exemplary and are not intended to limit the scope of this disclosure. While the components in FIG. 2 are illustrated as residing within the content providing computing device 102b, this is merely an example. In some embodiments, one or more of the components may reside external to the content providing computing device 102b. It should also be understood that, while the content providing computing device 102b in FIGS. 1 and 2 is illustrated as a single system, this is also merely an example. In some embodiments, the content providing functionality is implemented separately from the advertisement functionality, which may be implemented with separate hardware, software, and/or firmware.

FIG. 3 depicts a flowchart for dynamically including advertisement data within content, according to embodiments shown and described herein. As illustrated in block 350, the content uploader (e.g., via the uploading computing device 102a) can sign up for an account with the content provider (e.g., via the content providing computing device 102b). In block 352, the content uploader can schedule a broadcast of content and the content is posted on an internet site (such as an internet site provided by the content provider) for live and/or on-demand viewing. In block 354, the content uploader can download and install a utility application, as well as begin a broadcast. In block 356, within the downloaded utility application, the content uploader can select a break time and/or break duration of a desired break in the content. In block 358, at the end-user computing device 102c, the broadcast content is replaced with a dynamically chosen advertisement that is geo-targeted to the end-user locale, without buffering.

FIG. 4 depicts a flowchart for receiving on-demand content from the uploading computing device 102a, according to embodiments shown and described herein. As illustrated in block 450, content can be received from the uploading computing device 102a. In block 452, break times and/or durations may also be received from the uploading computing device 102a. In block 454, a content target demographic may be determined. As an example, if the content uploader is a grade school, the target audience may be current students of the school, prospective students of the school and/or parents of the current and/or prospective students. As such, the grade school may indicate to the content provider this target demographic, such that appropriate advertisements may be included with the content. In block 456, a tag may be created for the content that indicates time of a break and duration of a break. In block 458, the tag may be stored for a subsequent content request.

FIG. 5 depicts a flowchart for providing on-demand content with dynamically included advertisements to the end-user computing device 102c, according to embodiments shown and described herein. As illustrated in block 550, a request for content may be received from an end-user computing device 102c. In block 552, a demographic and location may be determined for the end-user. This may be determined by requiring the end-user to register with the content providing computing device 102b, by accessing an internet protocol (IP) address, and/or by other mechanisms. In block 556 the content may be provided to the end-user computing device 102c.

In block 558, a determination can be made regarding whether the content is complete. If so, the process may end. If not however, a determination can be made regarding whether a break has been reached, as defined by the content uploader. If not, the process may return to block 556. If so however, at block 562, an advertisement that substantially matches predetermined duration criteria, demographic criteria, geographic criteria, and/or other criteria may be accessed. At block 564 the advertisement may be provided to the end-user computing device 102c during the identified break. At block 566 a determination can be made regarding whether the break has ended. If so, the process returns to block 556 to resume providing the content. If not however, the process returns to block 564 to continue providing the advertisement.

FIG. 6 depicts a flowchart for providing broadcast content and including dynamically included advertisements to the end-user computing device 102c, according to embodiments shown and described herein. As illustrated in block 650, content, a target demographic, and a target geography may be received from the uploader. As discussed above, if the uploader is a grade school in Lexington, Kentucky the target demographic and geographic location may be school-aged children and parents that reside in the Southern/Midwestern United States. In block 652, a request for content may be received from an end-user computing device 102c, as well as demographic data and geographical data associated with the end-user. In block 654, the requested content may be provided to the end-user. In block 656, a determination can be made regarding whether the content has finished. If so, the process may end. If not however, the process advances to block 658 at which point, the content providing computing device 102b receives an indication of a break, where the indication includes a duration of the break. In block 660, the content providing computing device 102b can access an advertisement that corresponds to the duration of the break, the target demographic, the target geography, the end-user demographic, and/or the end-user geographic location. In block 662, the content can be interrupted during the break to provide the advertisement. At block 664 a determination can be made regarding whether the break duration has ended. If so, the process returns to block 654. If not however, the process returns to block 662.

FIG. 7 depicts a user interface that may be provided on the uploading computing device 102a for a content uploader to dynamically include an advertisement within broadcast content, according to embodiments shown and described herein. As illustrated in the embodiment of FIG. 7, the interface can include a media encoder window 702, a network spot window 704, a live stream window 706, and a status window 708. More specifically, the media encoder window 702 may be configured to provide a visual display of the content being provided. Additionally, audio levels, zoom levels, and/or other configurations may also be included in the media encoder window 702. The network spot window 704 may include one or more options for selecting a duration of the current break for providing an advertisement. While the example of FIG. 7 includes a 2 minute break, a 30 second break, a 60 second break, and a 5 minute break, some of these durations may be removed and/or other durations may be included.

The live stream window 706 may be configured to provide the title of the content, the name of the uploader, the audio device being utilized, the video device being utilized, the expected bit rate, the current bit rate, the elapsed time. Also included in the live stream window 706 is a start broadcast option and a stop broadcast option. An indication of a time when the next break begins and/or ends is also included.

FIG. 8 depicts a user interface that may be provided on the end-user computing device 102c, illustrating dynamic inclusion of an advertisement within content, according to embodiments shown and described herein. As illustrated, the user interface of FIG. 8 includes a video section 802 as well as one or more other options for selecting other content, altering presentation of the current content and/or viewing data about the current content.

It should be understood that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some implementations, the functions noted in the blocks may occur out of the order and/or not at all. For example, two blocks shown in succession may in fact be executed substantially concurrently or the blocks may sometimes be executed in the reverse order, depending upon the functionality involved.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. Further, the scope of the present disclosure is intended to cover all combinations and sub-combinations of all elements, features, and aspects discussed above. All such modifications and variations are intended to be included herein within the scope of this disclosure.

Therefore, at least the following is claimed:

1. A system for dynamically providing advertising data, comprising:
a memory component that stores a program that causes the system to perform at least the following:
receive uploaded content from an uploading computing device;
receive a desired break time and a desired break duration for the uploaded content;
determine a content target demographic for the uploaded content;
determine advertisement content that corresponds to the content target demographic;
create a tag for the uploaded content that indicates the desired break time and the desired break duration of a break; and
store the tag for a subsequent content request of the uploaded content.

2. The system of claim 1, wherein the program further causes the system to perform at least the following:
receive a request for the uploaded content, the request being received from an end-user computing device;
determine an end-user demographic of an end-user that requested the uploaded content;
retrieve the uploaded content and the tag; and
provide the uploaded content to the end-user computing device for presentation.

3. The system of claim 2, wherein the program further causes the system to perform at least the following:
determine whether presentation of the uploaded content is complete;
in response to determining that the presentation of the uploaded content is not complete, determine, from the tag, whether the break has been reached;
in response to determining that the break has been reached, access from the advertisement content, an advertisement that substantially matches the desired break time; and
provide, during the break, the advertisement to the end-user in place of the uploaded content.

4. The system of claim 3, wherein the program further causes the system to perform at least the following:
determine whether the break is complete; and
in response to determining that the break is complete, resume providing the uploaded content.

5. The system of claim 3, wherein the program further causes the system to determine a geographic location of the end-user and wherein accessing from the advertisement content comprises determining whether the advertisement substantially matches the geographic location of the end-user.

6. The system of claim 3, wherein the program further causes the system to determine whether the advertisement substantially matches the content target demographic.

7. The system of claim 1, wherein the uploaded content includes at least one of the following: stored content provided without buffering and live content provided without buffering.

8. A method for dynamically providing advertising data, comprising:
receiving uploaded content from an uploading computing device;
receiving a desired break time and a desired break duration of a desired break for the uploaded content;
determining a content target demographic for the uploaded content;
determining advertisement content that corresponds to the content target demographic;
creating, by a content providing computing device, a tag for the uploaded content that indicates the desired break time and the desired break duration;
receiving a request for the uploaded content, the request being received from an end-user computing device;
determining an end-user demographic of an end-user that requested the uploaded content;
retrieving the uploaded content and the tag; and
providing the uploaded content to the end-user computing device for presentation.

9. The method of claim 8, further comprising:
determining whether presentation of the uploaded content is complete;
in response to determining that the presentation of the uploaded content is not complete, determining, from the tag, whether the desired break has been reached;
in response to determining that the desired break has been reached, accessing an advertisement that substantially meets the desired break time; and
providing, during the desired break, the advertisement to the end-user in place of the uploaded content.

10. The method of claim 8, further comprising:
determining whether the desired break is complete; and
in response to determining that the desired break is complete, resuming providing the uploaded content.

11. The method of claim 8, further comprising determining whether the advertisement substantially matches a geographic location of the end-user.

12. The method of claim 8, wherein the uploaded content is live content provided without buffering.

13. The method of claim 8, further comprising determining whether the advertisement substantially matches the content target demographic.

14. A non-transitory computer-readable medium that includes a program that, when executed by a computing device, causes the computing device to perform at least the following:
receive uploaded content from an uploading computing device;
receive a break time and a break duration of a break for the uploaded content;
determine a content target demographic;
create a tag for the uploaded content that indicates the break time and the break duration;
store the tag for subsequent content request;
receive a request for the uploaded content, the request being received from an end-user computing device;
determine an end-user demographic for an end-user of the uploaded content;
retrieve the uploaded content and the tag;
provide the uploaded content to the end-user for presentation;
determine, from the tag, whether the break has been reached in presentation of the uploaded content;
determine whether the end-user demographic is substantially similar to the content target demographic; and
in response to determining that the end-user demographic is substantially similar to the content target demographic, provide, during the break, an advertisement to the end-user in place of the uploaded content.

15. The non-transitory computer-readable medium of claim 14, wherein determining, from the tag, whether the break has been reached comprises determining that the presentation of the uploaded content is not complete.

16. The non-transitory computer-readable medium of claim 14, wherein providing the advertisement to the end-user comprises determining whether the advertisement substantially matches the break time.

17. The non-transitory computer-readable medium of claim 14, wherein the program further causes the computing device to perform at least the following:
determine whether the break is complete; and
in response to determining that the break is complete, resume providing the uploaded content.

18. The non-transitory computer-readable medium of claim 14, wherein the program further causes the computing device to determine whether the advertisement substantially matches a geographic location of the end-user.

19. The non-transitory computer-readable medium of claim 14, wherein the uploaded content is live content provided without buffering.
